(19) United States
(12) Patent Application Publication
(10) Pub. No.: US 2023/0349443 A1
(43) Pub. Date: Nov. 2, 2023

(54) ABSORBER AND TRANSMISSION HAVING AN ABSORBER FOR DAMPING TORSIONAL VIBRATIONS

(71) Applicant: ZF FRIEDRICHSHAFEN AG, Friedrichshafen (DE)

(72) Inventors: Kyrill SIEMENS, Würzburg (DE); Andreas JANTSCHKE, Schonungen (DE)

(21) Appl. No.: 17/918,808

(22) PCT Filed: Apr. 21, 2021
(86) PCT No.: PCT/EP2021/060430

§ 371 Date: Oct. 13, 2022

(30) Foreign Application Priority Data
Apr. 30, 2020 (DE) 10 2020 205 467.3

(51) Int. Cl. F16F 15/14; F16F 15/34

(52) U.S. Cl. CPC F16F 15/145; F16F 15/34; F16F 2232/02

(57) ABSTRACT

An absorber for damping torsional vibrations in a drive train of a vehicle. The absorber includes one or more absorber masses and an absorber carrier, able to be coupled to the drive train, for receiving the one or more absorber masses . The one or more absorber masses are guided in a movable manner by the absorber carrier to at least partially damp the torsional vibrations. In addition, the absorber includes a balancing plate for balancing the absorber, said balancing plate being coupled to the absorber carrier for conjoint rotation, and a displacer element . The displacer element surrounds the one or more absorber masses at least partially, in order at least to reduce any penetration of a fluid at least partially surrounding the absorber as far as the one or more absorber masses. The displacer element is fastened to the balancing plate.

### CROSS REFERENCE TO RELATED APPLICATIONS

This is a U.S. national stage of Application No. PCT/EP2021/060430 filed Apr. 21, 2021. Priority is claimed on German Application No. DE 10 2020 205 467.3 filed Apr. 30, 2020 the content of which are incorporated herein by reference.

### BACKGROUND OF THE INVENTION

### 1. Field of the Invention

The present disclosure relates to an absorber and a transmission having such an absorber, the absorber configured to damp torsional vibrations in a drive train of a vehicle.

### 2. Description of Related Art

Relative to hybrid drive trains, in particular, two different concepts are pursued. Hybrid vehicles can have a transmission with a vibration decoupling system which serves, in particular, for damping vibrations in the drive train between an internal combustion engine and an electric drive machine. Such a decoupling system comprises, for example, a dual-mass flywheel (DMF), an absorber and a torsion damper, a so-called “KO clutch” for decoupling the internal combustion engine from the electric drive machine. A separation between the DMF and the absorber can be provided in the dry and the wet operating space by a bearing plate in the transmission. The DMF is located, for example, in the dry installation space and the absorber is located in the wet installation space.

In hybrid drive trains, in comparison with vehicles driven by an internal combustion engine, for example, the absorber is not located in the torque converter but directly in a housing of the transmission. Flyweights/absorber masses of the absorber for damping torsional vibrations in the drive train, for example, are immersed in a fluid located in the transmission and which serves for cooling and/or lubrication. The fluid is, for example, transmission oil. In particular when operated by an internal combustion engine, an immersion and removal of the flyweights can lead to the transmission oil being spun off and/or foamed. In the “foamed” state the transmission oil, for example, can flow back so slowly into a sump of the transmission that it is not available in a sufficient quantity for supplying other transmission components. As a result, a cooling system, which is dependent on the transmission oil, can overheat and be permanently damaged. Additionally, the immersion of the flyweights in the transmission oil can lead to energy loss due to so-called “drag torques” which arise due to shear effects on the transmission oil.

Document DE 10 2014 203 470 A1 discloses a centrifugal pendulum device for damping or absorbing torsional vibrations, comprising pendulum masses distributed over a circumference. The centrifugal pendulum device is characterized in that it comprises a lateral protective wall which is fastened to a burst protection ring and to a fastening of a pendulum mass carrier/absorber mass carrier for receiving the pendulum masses. The protective wall serves in this case as visual cover and as protection from the penetration of foreign bodies into the centrifugal pendulum device.

An attachment of the protective wall requires a modification to a fastening of the pendulum mass carrier, whereby a mechanical load-bearing capacity of the riveted connection can be reduced.

Published patent application DE 10 2014 211 812 A1 discloses a torque transmission device with a centrifugal pendulum. Pendulum masses/absorber masses of the centrifugal pendulum are arranged in this case in a closed cage in order to be received therein in a “flange-free” manner, and roll on roller tracks provided on an inner circumference of the cage.

Since the cage is provided at the same time for receiving the pendulum masses, a corresponding design of the cage is provided for receiving the pendulum masses, resulting in increased technical effort when producing the cage.

Published patent application DE 10 2016 221 579 A1 discloses a centrifugal pendulum comprising a pendulum mass for damping or absorbing torsional vibrations. The pendulum mass is additionally encapsulated in a fluid-tight manner by a housing. The housing is fastened to a pendulum flange/absorber mass carrier.

A fastening of the housing to a pendulum flange, for example, brings about a reduction in a mechanical load-bearing capacity of the pendulum flange and thus a reduced mechanical load-bearing capacity of the centrifugal pendulum.

The document WO 2015/165672 A1 discloses a vibration damper unit with a movably guided absorber mass for damping a vibration component. The absorber mass is separated by a sealing membrane from a spring region of a torsion damper in order to reduce at least a penetration of a lubricant to the absorber mass.

It is additionally provided to fasten the sealing membrane to a guide structure/an absorber mass carrier, whereby a modification of the guide structure and thus additional technical effort is required.

### SUMMARY OF THE INVENTION

An object of one aspect of the present invention thus can be seen in providing an improved design for an absorber, in particular for reducing the effects of a fluid.

According to a first aspect, the present invention relates to an absorber, for example for damping torsional vibrations in a drive train of a vehicle. The absorber comprises one or more absorber masses and an absorber carrier able to be coupled to the drive train for receiving the one or more absorber masses. The one or more absorber masses are guided in a movable manner by the absorber carrier in order to at least partially damp the torsional vibrations. Additionally the absorber comprises a balancing plate provided for balancing the absorber, said balancing plate being coupled to the absorber carrier for conjoint rotation, and a displacer element. The displacer element surrounds the one or more absorber masses at least partially, in order at least to reduce any penetration of a fluid at least partially surrounding the absorber as far as the one or more absorber masses, wherein the displacer element is fastened to the balancing plate.

The absorber can be used, in particular, in a vehicle transmission for vibration decoupling. For example, an at least partial vibration decoupling between an internal combustion engine and an electric drive machine in a transmission of a hybrid vehicle can be achieved by the absorber.

The absorber carrier is coupled, for example, fixedly in terms of rotation to the drive train and, for receiving the absorber masses, comprises, for example, one or more bolts which in each case pass through one of the absorber masses in an axial direction and thereby are able to secure said absorber masses in the radial direction. In this case the absorber masses can be received such that, for example, they are movably guided with play of movement in the radial direction.

Thus torsional vibrations within the drive train can be absorbed or at least damped by displacements of the absorber masses.

The absorber masses can protrude, for example, in the radial direction into a pan for storing the fluid. The pan is filled up with the fluid, for example, to a fluid level.

The absorber carrier comprises, for example, one or two flange parts for securing in the axial direction, said flange parts being produced from a hardened steel in order, for example, to withstand mechanical loads at a maximum rotational speed of the absorber.

The balancing plate can be designed such that an imbalance of the absorber is at least reduced by a suitable mass distribution of the balancing plate and/or by balance-centering the balancing plate. For reducing the imbalance, the balancing plate can be adapted individually to the absorber and the imbalance thereof.

For a reduced technical effort for adapting the balancing plate, this balancing plate can be produced at least partially from unhardened steel, for example in contrast to the absorber carrier. As a result, the balancing plate can be more easily drilled and welded for the adaptation relative to hardened steel.

The displacer element surrounds the absorber masses, for example, such that a flow of the fluid to the absorber masses is reduced. Alternatively or additionally, the displacer element can serve as a splash guard against the fluid. The displacer element protrudes over the absorber masses, for example in the radial direction, such that this displacer element is at least partially immersed in the fluid in order to shield the absorber masses at least partially against the fluid and thereby to reduce the penetration of fluid to the absorber masses.

The fluid is, for example, a coolant and/or a lubricant. When using the absorber in a transmission, the fluid is, for example, a transmission oil which firstly serves for lubrication and secondly serves for cooling components.

The displacer element is connected, for example, to the balancing plate fixedly in terms of rotation, such that this displacer element can rotate partially below the fluid level in the fluid when the absorber is operated. In order to reduce a foaming of the fluid and drag torques on the fluid, the displacer element can have a smooth or “closed” surface contour at least in a region which is below the fluid level.

In some exemplary embodiments, the absorber additionally comprises a hub, which can be coupled to the drive train, wherein the balancing plate and the absorber carrier are connected fixedly in terms of rotation to the hub.

The hub is connected, for example, fixedly in terms of rotation to the drive train. To this end, the hub has, for example, an inner toothing which positively engages with an outer toothing of a shaft of the drive train.

In each case, the balancing plate and the absorber carrier can be coupled fixedly in terms of rotation to the hub, for example by one or more riveted connections. Alternatively, the balancing plate and the absorber carrier can be coupled fixedly in terms of rotation to the hub by one or more common riveted connections.

A connection of the balancing plate and the absorber carrier to the drive train via the hub can be implemented in a technically simpler manner than a direct rotationally fixed connection of the absorber carrier and the balancing plate to the shaft since, for example, no toothing is required with the balancing plate and the absorber carrier and/or no hardening thereof is required.

In some exemplary embodiments, the displacer element surrounds the absorber masses at least partially radially and axially.

For example, it can be understood thereby that the displacer element protrudes beyond the absorber masses in the radial direction and is arranged radially outside the absorber masses.

As a result, for example, a penetration of the fluid from the radial and axial direction is reduced.

In some exemplary embodiments, the displacer element has a U-shaped profile at least partially radially and axially surrounding the absorber masses.

The U-shaped profile can be understood to mean a so-called “U-profile” or an open profile in one direction.

The absorber masses and the displacer element are arranged, for example, such that the absorber masses at least partially protrude into the U-shaped profile in the radial direction. Thus the absorber masses can be surrounded at least partially in the radial direction and in the axial direction by the U-shaped profile.

As result, a penetration of the fluid from the axial and radial direction can be reduced.

Ideally, the displacer element is arranged such that the U-shaped profile of the displacer element displaces the fluid from a deflection region of the absorber masses.

In some aspects of the invention, the absorber masses are movable in a radial direction within a deflection region. The displacer element can additionally be arranged such that the absorber masses are spaced apart in the radial direction from the displacer element when deflected within the deflection region.

The deflection region can be understood to mean a region in which the absorber masses can move when the absorber is rotated and the absorber masses are deflected.

By a spacing of the displacer element relative to the deflection region of the absorber masses, the absorber masses can be prevented from striking and/or rubbing against the displacer element.

The spacing in the radial direction can optionally be selected such that fluid, which penetrates through leakages or through the hub to the absorber masses and collects inside the displacer element, is carried out of the displacer element by the rotation of the absorber masses.

In some aspects of the invention, the displacer element is fastened to the balancing plate by at least one riveted connection.

The riveted connection has the advantage relative to other possibilities for connecting the displacer element to the balancing plate, for example, that the riveted connection, for example, can be released for maintenance and/or repair purposes.

In some aspects of the invention, the displacer element is fastened to the balancing plate by at least one material connection.

The material connection can be produced, for example, by welding or by soldering. A material connection of the balancing plate and the displacer element is able to be implemented, in particular, advantageously and technically when the balancing plate and the displacer element are produced from unhardened steel at least in the region of the material connection.

In some aspects of the invention, the balancing plate is configured to receive one or more balancing masses.

The balancing plate comprises, for example, corresponding pockets or receivers for receiving the balancing masses.

The balancing plate can also be configured, in particular, for receiving the balancing masses by being produced at least partially from unhardened steel or a different steel or a material which is suitable for a welding or soldering process. In this case, the balancing masses can be welded to the balancing plate.

An attachment of the balancing masses to the balancing plate can thus be carried out, for example, by an automated welding process.

In some aspects of the invention, the displacer element comprises an opening for removing fluid which has penetrated to the one or more absorber masses.

The fluid can penetrate to the absorber masses, for example, via leakages or further openings in the displacer element. In some cases, the penetration of the fluid can be desired for the purpose of supplying other components with the fluid.

This fluid can be removed again via the opening in order to avoid or to reduce drag torques and a “frothing” or foaming of the fluid by the absorber masses.

In some aspects of the invention, the displacer element is designed in one piece as a bent workpiece.

As a result, a technical effort when producing the displacer element can be reduced since, for example, it is not necessary to join together a plurality of components. Additionally, when designed as a one-piece workpiece the displacer element can have a greater mechanical load-bearing capacity relative to a displacer element comprising a plurality of components joined together.

According to one aspect, the present invention relates to a transmission for a drive train of a vehicle. The transmission comprises a housing with a pan for storing a fluid provided for cooling and/or lubrication, and an absorber which can be coupled to the drive train for damping torsional vibrations. The absorber is at least partially arranged in the pan. The absorber is also configured according to one of the exemplary embodiments described above, in order to reduce at least a penetration of the fluid to one or more rotatably arranged absorber masses of the absorber.

As described above, a foaming of the fluid and an undersupply of the transmission components with the fluid associated therewith can be avoided or at least reduced thereby. As a result, for example, a sufficient cooling and lubrication of the components can be achieved.

### BRIEF DESCRIPTION OF THE DRAWINGS

Some examples of exemplary embodiments of the invention are described in more detail hereinafter merely by way of example, with reference to the accompanying figures. In the figures:

FIG. 1 is a part of a conventional transmission of a vehicle in a sectional view;

FIG. 2A is an absorber with a displacer element; and

FIG. 2B is an absorber.

### DETAILED DESCRIPTION OF THE PRESENTLY PREFERRED EMBODIMENTS

Various exemplary embodiments are now described in more detail and with reference to the accompanying drawings in which some exemplary embodiments are shown.

Although exemplary embodiments can be modified and changed in different ways, exemplary embodiments are shown as examples in the figures and are described in detail herein. However, it should be made clear that it is not the intention to limit the exemplary embodiments to the respectively disclosed forms but rather that exemplary embodiments are intended to cover all functional and/or structural modifications, equivalents and alternatives which are within the scope of the invention.

Vehicle transmissions can be partially filled with a fluid provided for cooling and/or lubrication. The fluid is, for example, transmission oil which can firstly act as a lubricant and secondly as a coolant for the transmission.

In transmissions with a plurality of components a requirement for transmission oil can be high, so that components of the transmission are at least partially located below a fluid level of the transmission oil in the transmission. For example, an absorber for damping torsional vibrations can be partially immersed in the transmission oil.

When the absorber is rotated, an immersion and removal of the absorber masses, which are fastened to the absorber over a circumference of the absorber, can lead to the transmission oil being spun off and foaming. Foamed transmission oil can flow back slowly into a pan or a sump provided for storing the transmission oil, which is unsatisfactory, so that sometimes insufficient transmission oil can be available for supplying components in the transmission.

This is intended to be clarified hereinafter with reference to an example.

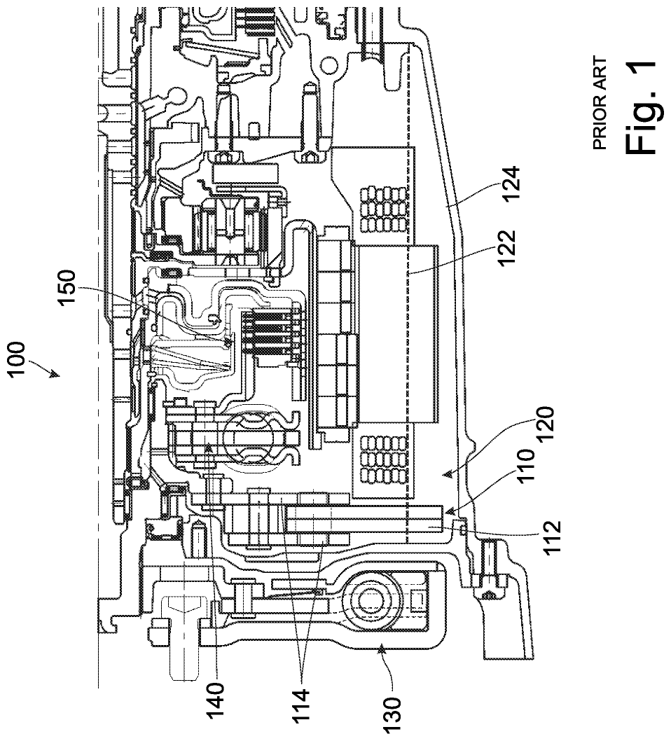

FIG. 1 shows a part of a conventional transmission 100 as can be used, for example, in a (hybrid) vehicle.

The transmission 100 comprises a speed-adaptive absorber 110, a fluid 120 located in the transmission 110, a dual-mass flywheel 130, a torsional vibration damper 140, and a separating clutch 150. In particular, when used in a hybrid vehicle, the separating clutch 150 can be provided for decoupling an internal combustion engine from an electric drive.

The fluid 120 is, for example, transmission oil, which serves for the cooling and lubrication of components of the transmission 100. Depending on a requirement for transmission oil 120, a fluid level 122 of the transmission oil 120 can be high, such that the absorber 110 is partially immersed in the transmission oil in a radial direction.

As can be seen, in particular, absorber masses 112 which are arranged over a circumference of the absorber 110 are immersed in the transmission oil 120.

The absorber masses 112 are arranged in an axial direction between flange parts 114 of an absorber carrier. The absorber masses 112 are, for example, movably arranged so that they can contribute to the damping of torsional vibrations or torsional oscillations by displacements, in particular, in the radial direction.

When the absorber 110 is rotated, the absorber masses 112 can foam the transmission oil so that it can flow back slowly into a sump 124 of the transmission 100 and thus is sometimes not available for the cooling and/or the lubrication. Thus, as a result, it can lead to an insufficient cooling and/or lubrication of further components of the transmission 100.

Thus an object of the present invention is providing an improved design for an absorber.

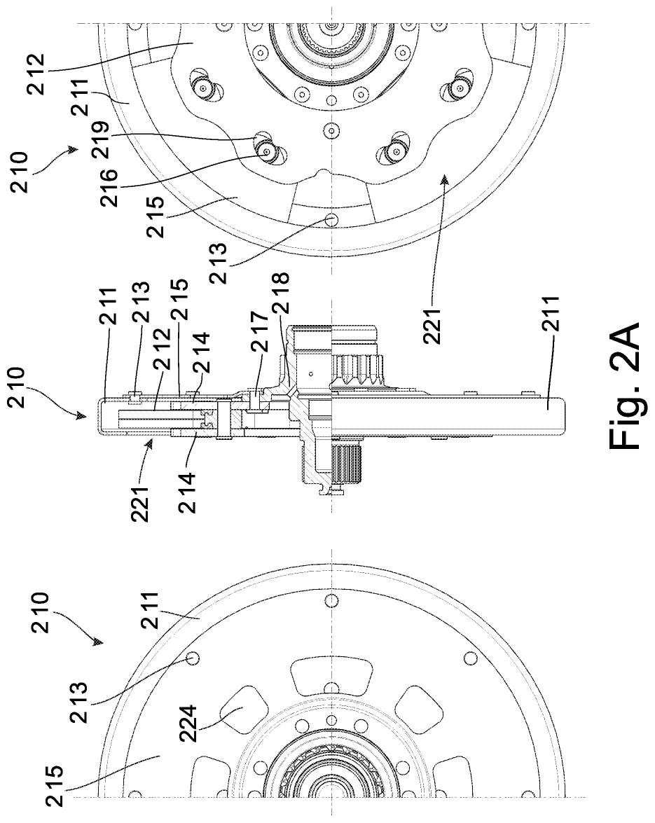

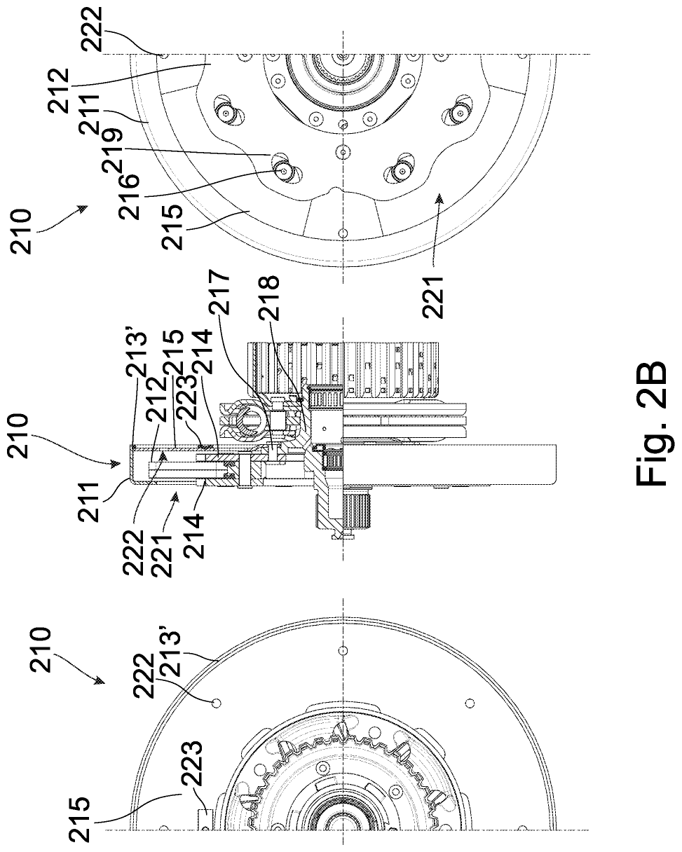

FIG. 2a shows a first exemplary embodiment of an absorber 210, which is configured at least to reduce a penetration of a fluid to an absorber mass 212 of the absorber 210.

In particular, FIG. 2A shows a rear view (left), a sectional image (center) and a front view (right) of the first exemplary embodiment.

The absorber mass 212 is arranged in an axial direction between flange parts of an absorber carrier 214. The flange parts 214 can be provided with bolts 216 that penetrate through openings 219 of the absorber mass 216 in the axial direction for receiving the absorber mass 216. The openings 219 are configured such that the absorber mass 212 is movably guided within a deflection region between the flange parts 214 in the radial direction and peripheral direction. Thus, due to displacements within the deflection region, the absorber mass 212 can cause changes to a moment of inertia of the absorber 210, which lead to the damping or absorption of torsional vibrations which originate from a drive train coupled to the absorber 210.

Moreover, the absorber 210 comprises a balancing plate 215 which is provided for balancing/counterbalancing the absorber 210 and which, together with the absorber carrier, is coupled by a riveted connection 217 fixedly in terms of rotation to a hub 218. The hub 218 is additionally coupled by a shaft to the drive train via a toothing.

Alternatively, the balancing plate 215 and the absorber carrier can be separately coupled and in some exemplary embodiments additionally directly coupled, i.e. without an interposed hub, to the drive train or to the shaft of the drive train.

The balancing plate 215 has a plurality of balancing recesses 224 which, for example for adjusting a mass distribution of the balancing plate 215, are incorporated therein in order to reduce or absorb an imbalance of the absorber 210 (“balancing/counterbalancing”).

Moreover, the absorber 210 comprises a displacer element 211, which at least partially surrounds the absorber mass 212 so as at least to reduce a penetration of a fluid, which at least partially surrounds the absorber 210, to the absorber mass 212. The displacer element 211 overlaps the balancing plate 215 in the radial direction and is fastened to the balancing plate 215 in the region of a radial overlap by a riveted connection 213. The riveted connection 213 comprises a plurality of rivets, as visible in the rear view of the absorber 210.

The connection of the displacer element 211 to the absorber 210 via the balancing plate 215 can be advantageous, for example, relative to a connection via one or both of the flange parts 214, since as a result no modification of the absorber carrier or the connection thereof to the drive train is required.

Additionally, in contrast to the flange parts 214, the balancing plate 215 is produced, for example, from unhardened steel/material, whereby the connection of the displacer element 211 via the balancing plate 215 can require less technical effort than the connection of the displacer element 211 via the flange parts 214 or the absorber carrier. For example, it can be less technical effort to incorporate bores for the riveted connection 213 in the balancing plate 215 than in the absorber carrier 214.

The displacer element 211 is configured such that it surrounds the absorber mass 212 at least partially radially and axially. As the first exemplary embodiment shows, the displacer element 211 fully covers/surrounds, in particular, the absorber mass 212 in the radial direction and at least partially from both sides in the axial direction.

To this end, the displacer element 211 has a U-shaped profile, also called the “U-profile”. The absorber mass 212 is arranged relative to the displacer element 211 such that the absorber mass 212 partially protrudes into the U-profile.

As a result, the transmission oil can be displaced from the deflection region or movement region of the absorber mass 212, and a penetration of the transmission oil to the absorber mass 212 can be at least reduced thereby relative to an absorber without such a displacer element 211.

Additionally, the displacer element 211 can reduce a quantity of transmission oil which can penetrate to the absorber mass 212 by transmission oil being splashed around.

As a result, a foaming and/or frothing of the transmission oil can be reduced or prevented by the absorber mass 212.

As a result, the cooling and/or lubrication can be ensured by the transmission oil.

The displacer element 211 can be designed, for example, as a one-piece bent workpiece. Expensive and time-consuming joining processes when producing the displacer element can be avoided thereby.

The displacer element 211 is additionally configured and arranged, for example, such that the absorber mass 212 has a safety spacing from the displacer element 211 in the radial direction, in particular in the case of maximum deflections in the radial direction. As a result, it is possible to avoid wear and any damage caused by collisions of the displacer element 211 with the absorber mass 212.

The displacer element 211 is connected on one side, i.e. on an axial side of the absorber mass 212, to the balancing plate 215 in order to reduce, for example, a mounting effort relative to a two-sided connection of the displacer element 211.

On a side of the absorber mass 212 opposing the balancing plate 215 in the axial direction, the displacer element 211 extends sufficiently far inwardly in the radial direction that an opening 221 is formed radially inside the displacer element 211, transmission oil, which has penetrated to the absorber mass 212, being able to be carried away via said opening by the absorber mass 212. For example, the absorber mass 212 can carry away the transmission oil through the opening 221 by rotation.

FIG. 2b shows a second exemplary embodiment of the absorber 210.

In particular, FIG. 2B shows a rear view (left), a sectional image (center) and a front view (right) of a second exemplary embodiment.

In contrast to the first exemplary embodiment shown in FIG. 2A, the displacer element 211 does not overlap the balancing plate 215 in the radial direction but is flush in the radial direction or is arranged “in abutment” with the balancing plate 215 and connected thereto by a material connection 213′. The material connection 213′, for example, is a welded connection in the form of a so-called “weld seam”.

By a connection of the displacer element 211 to the balancing plate 215 by the welded connection 213′, a number of components and costs can be saved relative to a connection by the riveted connection 213 as in the first exemplary embodiment.

For further cost saving, the welded connection 213′ can be automated and produced mechanically.

The flange parts 214 are, for example, made of hardened steel, as is common in practice. For the person skilled in the art, it is clear that a welded connection of the absorber carrier/flange parts 214 to the displacer element might be technically more complex to produce than the welded connection 213′. By the connection of the displacer element 211 shown in FIG. 2b, therefore, costs can be saved, for example, when producing the absorber 211.

Moreover, the balancing plate 215 has a plurality of recesses 222 which can serve as an improvement for carrying away transmission oil, in the same manner as the opening 221 for carrying away/removing the transmission oil.

Additionally, the balancing plate 215 has a balancing mass 223 which is welded, for example, onto the balancing plate 215.

The above-described absorber 210 can be used, for example, in a similar manner to the absorber 110 in a transmission for a drive train of a vehicle in which the absorber 210 protrudes into a pan which is filled with transmission oil.

The aspects and features which are described together with one or more of the previously detailed examples and figures can also be combined with one or more of the other examples, in order to replace the same feature of the other example, or additionally to incorporate the feature in the other example.

Moreover, the following claims are incorporated herewith in the detailed description, where each claim can be a separate example per se. Whilst each claim can be a separate example per se, care should be taken that - whilst an independent claim can refer in the claims to a specific combination with one or more other claims,—other examples can also comprise a combination of the dependent claim with the subject of each other dependent or independent claim. Such combinations are explicitly proposed here, provided it is not specified that a specific combination is not intended. Moreover, features of a claim are intended to be incorporated in every other independent claim, even if this claim is not made directly dependent on the independent claim.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-11. (canceled)

12. An absorber, configured to damp torsional vibrations in a drive train of a vehicle, comprising:
one or more absorber masses;
an absorber carrier configured to couple to the drive train and receive the one or more absorber masses, which are guided in a movable manner by the absorber carrier to at least partially damp the torsional vibrations;
a balancing plate provided for balancing the absorber, the balancing plate coupled to the absorber carrier for conjoint rotation; and
a displacer element fastened to the balancing plate, which surrounds the one or more absorber masses at least partially, configured to at least reduce any penetration of a fluid at least partially surrounding the absorber as far as the one or more absorber masses.

13. The absorber as claimed in claim 12, further comprising:
a hub coupled to the drive train, wherein the balancing plate and the absorber carrier are connected fixedly in terms of rotation to the hub.

14. The absorber as claimed in claim 12, wherein the displacer element surrounds the one or more absorber masses at least partially radially and axially.

15. The absorber as claimed in claim 12, wherein the displacer element has a U-shaped profile at least partially radially and axially surrounding the one or more absorber masses.

16. The absorber as claimed in claim 12,
wherein the one or more absorber masses are movable in a radial direction within a deflection region; and
wherein the displacer element is arranged such that the one or more absorber masses are spaced apart in the radial direction from the displacer element when deflected within the deflection region.

17. The absorber as claimed in claim 12, wherein the displacer element is fastened to the balancing plate by at least one riveted connection.

18. The absorber as claimed in claim 12, wherein the displacer element is fastened to the balancing plate by at least one material connection.

19. The absorber as claimed in claim 12, wherein the balancing plate is configured to receive one or more balancing masses.

20. The absorber as claimed in claim 12, wherein the displacer element comprises an opening for removing fluid which has penetrated to the one or more absorber masses.

21. The absorber as claimed in claim 12, wherein the displacer element is configured as a one piece bent workpiece.

22. A transmission for a drive train of a vehicle, the transmission comprising:
a housing with a pan configured to store a fluid provided for cooling and/or lubrication; and
an absorber configured to couple to the drive train for damping torsional vibrations,
wherein the absorber is at least partially arranged in the pan and comprises:
one or more absorber masses;
an absorber carrier configured to couple to the drive train and receive the one or more absorber masses, which are guided in a movable manner by the absorber carrier to at least partially damp the torsional vibrations;
a balancing plate provided for balancing the absorber, the balancing plate coupled to the absorber carrier for conjoint rotation; and
a displacer element fastened to the balancing plate, which surrounds the one or more absorber masses at least partially, configured to at least reduce a penetration of the fluid to one or more rotatably arranged absorber masses of the absorber.
